(19) United States
(12) Patent Application Publication
(10) Pub. No.: US 2016/0095169 A1
(43) Pub. Date: Mar. 31, 2016

(54) METHOD FOR DETECTING THE IDENTITY OF A POT ON A COOKING POINT OF A HOB AND SYSTEM OF A HOB WITH A POT

(71) Applicant: E.G.O. Elektro-Geraetebau GmbH, Oberderdingen (DE)

(72) Inventor: Antoni Torres Sanchez, Barcelona (ES)

(21) Appl. No.: 14/842,458

(22) Filed: Sep. 1, 2015

(30) Foreign Application Priority Data
Sep. 29, 2014 (EP) 14186750.7

(51) Int. Cl. H05B 6/06; F24C 7/00; H05B 6/12

(52) U.S. Cl. CPC H05B 6/062; H05B 6/1209; F24C 7/002

(57) ABSTRACT

A set of a hob with a hob plate and a cooking point at the hob plate together with a pot, wherein the hob has at least one heating element placed underneath the hob plate and wherein the cooking point is provided with a pot sensing means for detecting presence of a pot on the cooking point, wherein the hob also has a control and receiving means connected to the control, wherein the pot is provided with a temperature sensor and a transmitter attached to it, wherein the transmitter is transmitting at least two sets of data, wherein the first set of data is an individual pot identifier and the second set of data is related to the temperature state of the pot being measured by the temperature sensor.

### CROSS-REFERENCE TO RELATED APPLICATIONS

This application claims priority to European Application No. 14186750.7, filed on Sep. 29, 2014, the contents of which are hereby incorporated herein in its entirety by reference.

### TECHNOLOGICAL FIELD

The invention is directed to a method for detecting the identity of a pot on a cooking point of a hob, as well as a system of a hob together with a pot.

### BACKGROUND

It is common knowledge in the art that for detecting the sheer presence of any pot on a cooking point of an induction cooking field, an induction coil is with rather low power switched on for a short time span and the induction current is measured. If there is no suitable pot present above the induction coil, the induction current is characteristically different from the case where there is a suitable pot present. In the first case, no substantial amount of energy can be transmitted, whereas in the second case an energy transfer is possible. However, there still is the problem that in this method only the presence of a suitable object to be heated can be detected, but a differentiation between two or more pots with specific and/or different characteristics is not possible, especially in the case where these pots are similar or even identical. An identity of the pot being placed on the cooking point cannot be detected.

### BRIEF SUMMARY

The problem of the invention is to provide an above-mentioned method as well as an above-mentioned system, with which problems of the prior art can be avoided and wherein it is preferably possible to differentiate between different pots placed on a cooking point of a hob. Advantageously, this is possible in the case where a pot is moved from one cooking point of the hob to another and wherein, irrespective of the specific location of the pot above any of the heating elements of the hob, the pot can be heated in the same manner or with the same power level and, possibly, with the same continuous cooking program.

This problem is solved by a method as well as a system of the invention. Advantageous and preferred embodiments are the subject-matter of the subclaims and will be described in greater detail hereinafter. Some of the features will be described only in connection with the method or only in connection with the system. Irrespective of this, those features shall be applicable to and shall characterize the method as well as the system in independent manner. The wording of the claims is made a content of the description by express reference.

In the method according to the invention, it is provided that for detecting the identity of a pot on a cooking point of a hob with a hob plate, data transmitted from the pot is used. The hob itself has at least one heating element being placed underneath the hob plate and being provided for the heating function of the cooking point. The heating element preferably is an induction heating element, wherein in this case the hob is an induction hob. The cooking point is provided with a pot sensing means for detecting presence of a pot on the cooking point. Such a pot sensing means can on the one hand be, in the case of an induction coil as heating element, this induction coil itself, as has been explained before and as known in the art. Another pot sensing means could be a separate coil, for example according to EP 788293 A2.

For transmitting the data of the pot, a temperature sensor and a transmitter are attached to the pot, in particular permanently attached to the pot. This can be in the handle or, alternatively, in the form of a removable tag or clip or the like. The transmitter is transmitting at least two sets of data. Preferably, the transmitter is transmitting only two or exactly those two sets of data. The first set of data is an individual pot identifier, for example a pot unique identifier number. This individual pot identifier must be different for all the pots of the system or to be used on this hob when the function according to the invention shall be used. The second set of data is related to the temperature state of the pot or the temperature of an outer side of the pot or the temperature of the inside of the pot, which can be varied. This temperature state of the pot or its load is measured by the temperature sensor. These two sets of data are transmitted to an induction system generator or a control of one heating element, respectively, or a hob control, wherein preferably these two sets of data are available for all cooking points of the hob. The control in each case has a receiver or is connected to such a receiver, the receiver being able to receive the data from the transmitter.

A power profile template is defined for the heating element, preferably a rather simple power profile template made up of a rise of the power and a fall of the power, possibly both being continuous or linear, and potentially having a phase of constant power in-between. When the pot sensing means has detected presence of any pot on a cooking point, this cooking point or its heating element, respectively, is activated with this power profile template. This again provokes a temperature change in the pot being placed above the cooking point. Some time or delay is given because the pot has a defined thermal capacitance and heating up of the pot or its load takes some time, for example from some seconds up to one to three minutes as is known in the art. The pot and its contents are beginning to heat up with a rising temperature. With the above-mentioned delay due to the thermal capacitance, the temperature sensor at the pot detects, potentially with the thermal capacitance delay, the profile of the power which is represented in the temperature change or at least can be recognized in the temperature change. This temperature information is then sent back via the transmitter as an above-mentioned second set of data to the control. Then it can be determined whether this detected temperature profile corresponds to the power profile template generated by the heating element. Preferably, the power profile template is rather characteristic so that it will usually not occur during a regular cooking process. In case of a match of the power profile template on the one hand and the temperature information of the transmitter on the other hand, the pot with this pot identifier sent as the first set of data is identified and potentially stored in the control to be placed on this cooking point. Basically, the invention uses the principle of generating a characteristic heating signature, and in the case of several pots being placed on several cooking points of the hob, only one pot could be heated at least roughly corresponding to this heating signature, which again is recognized and evaluated by the temperature sensor and the control.

In practice, the transmitters of other pots being placed on the hob will also send their data back to a control of the hob, which preferably is an induction hob. However, they do not experience any characteristic heating signature of the heating element to detect the identity of a pot placed on it, for example because they are simply continuously heated for a regular cooking operation. Then they will of course send back data to the control of the hob in form of their individual pot identifier and a temperature state, wherein this temperature state will then most probably be rather constant or, in case if it should be changing, it will not be changing in a characteristic way according to the heating signature corresponding to the power profile template.

With this principle of the invention it is for example possible to keep up an automatic cooking program for any identified pot even if this is moved to another cooking point. In this case, the previous cooking point recognizes the removal of the pot and another cooking point will detect the appearance of a pot above it with the pot sensing means. This alone is not yet a definite proof that the pot identified before has been moved to the new cooking point. If then the new cooking point will again start the steps of identifying a pot placed on it by being activated with a power profile template, this profile can again be seen in the temperature response of this pot. If then the pot has been identified and detected as being placed on this new cooking point, the aforementioned automatic cooking process can be continued. Alternatively, the heating power of this new cooking point can be adjusted such that the temperature of this pot will stay rather constant.

In practice, the user only needs to move the pot from the old cooking point to a new cooking point without any adjustments to the power regulation and without the use of any operating elements. This largely facilitates a cooking process, especially in the case of an above-mentioned automatic cooking program.

Of course, the temperature information sent back by the transmitter can also be used for temperature regulation of the heating element or the pot placed above it, respectively. However, this makes the use of a rather exact temperature sensor mandatory, which is potentially expensive and complex. To recognize the temperature signal roughly corresponding to the power profile template is much easier and is basically more related to only rise and fall of a temperature over a certain duration.

In a further embodiment of the invention, it can be defined in the control of the hob that a specific pot with a specific pot identifier is always used with a specific predefined temperature, for example to heat up milk up to a temperature of between 40° C. and 50° C. If this pot is set on the hob at a specific cooking point, by actuating only one control element after detection and identification of this specific pot as described before, the heating element of this cooking point is activated with an energy level or a power level, respectively, to heat the pot with this specific predefined temperature. This temperature may then be controlled with the second set of data with the temperature information of the pot, which then should be sufficiently accurate.

In a further embodiment of the invention, in the control of the hob are not only stored the different pot identifiers for recognizing the pots. In this case, to introduce a new pot to the hob a learning process can be started according to a defined set of steps, where basically only this new pot sends its individual pot identifier to receiving means in the hob to be stored in the control of the hob.

Together with an individual pot identifier it is possible to store information about the physical and thermal properties of this pot. This means that the control can have stored information about how much heating power must be generated by the heating element to heat up the pot to a certain temperature. Then it can be also stored in the control a specific temperature difference between the temperature measured by the temperature sensor on the one hand and the actual temperature of a content in the pot. This can be used for a more accurate temperature regulating process in the pot by use of the temperature sensor and its data transmitted to the control.

The power profile template preferably comprises at least one rise of power to a maximum power level and, furthermore, at least one fall of power to zero power level. It may be useful in this case to make the rise of power faster or to have a shorter time than the fall of power. This leads to a better recognizable process.

In a further embodiment of the invention, the power profile template comprises at least one phase of constant power, wherein this constant power preferably differs from zero power. More preferably, the power profile template comprises no phase of zero power or more than a few seconds.

In a further embodiment of the invention, the power profile template has a rise and/or a fall of power within each case a specific rise duration and a specific fall duration. Both rise and fall should take place continuously or linearly, respectively. More preferably, the rise of power takes less time than the fall of power.

The phase of constant power is preferably between the rise and the fall of power. This phase of constant power lasts for a continuous duration, which should be longer than the rise duration or the fall duration.

In a preferred embodiment of the invention, the heating element effects at least three rises of power and three falls of power or three times the same rise and fall cycle. This provides for a rather good and safe recognition of a pot.

According to the invention there is also provided a set of a hob with a hob plate and a cooking point at the hob plate together with a pot, wherein the hob has at least one heating element placed underneath the hob plate and wherein the cooking point is provided with a pot sensing means for detecting presence of a pot on the cooking point, wherein the hob also has a control and receiving means connected to the control. The pot is provided with a temperature sensor and a transmitter attached to it, wherein the transmitter is transmitting at least two sets of data, wherein the first set of data is an individual pot identifier (MAC) and the second set of data is related to the temperature state of the pot being measured by the temperature sensor.

These and further features can be gathered not only from the claims but also from the description and the drawings, wherein the individual features can in each case be realized on their own or several combined together in an embodiment of the invention and in other areas and can constitute advantageous and independently patentable configurations for which protection is claimed here. Subdividing the application into sub-headings and individual sections does not restrict the general validity of what is said therebeneath or therein.

### BRIEF DESCRIPTION OF THE SEVERAL VIEWS OF THE DRAWINGS

Some embodiments of the invention are shown in the drawings and are explained hereinafter in detail. In the drawings show:

FIG. 1 is a schematic representation of a hob with four induction coils as heating elements and two pots placed on the hob;

FIG. 2 is a schematic drawing of how in FIG. 1 the two sets of data of each pot are given to one induction coil; and

FIGS. 3 to 8 are different power profile templates generated by the induction coil and the varying temperature responses at the pots depending on the power profile template and size and load of the pots.

### DETAILED DESCRIPTION

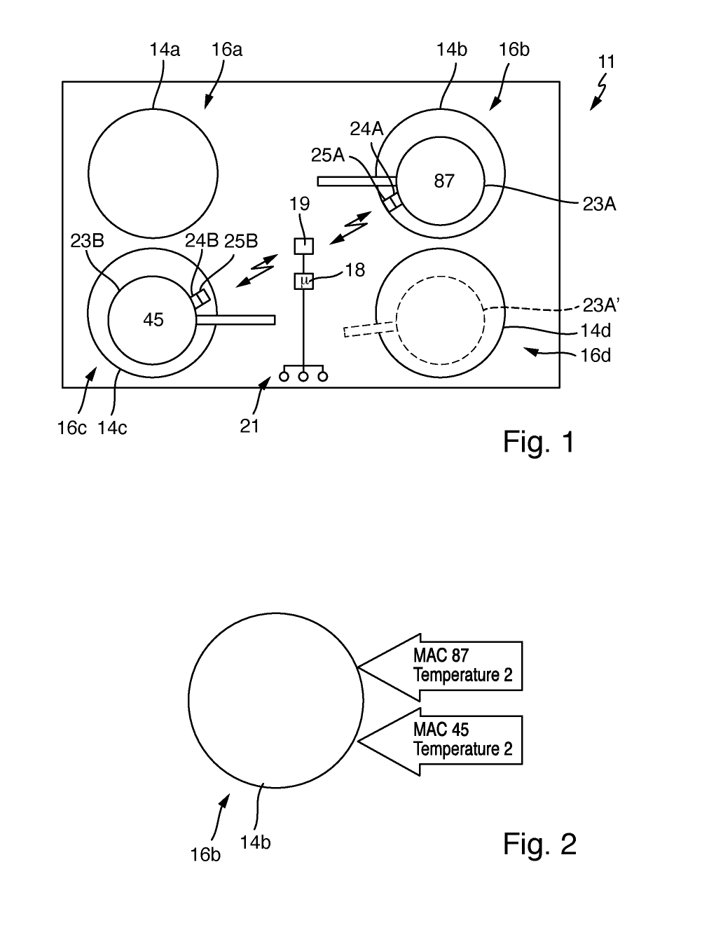

In FIG. 1 is schematically illustrated a hob 11 according to the invention as part of the inventive system together with at least one pot or, in this case, two pots 23A and 23B. Hob 11 has a hob plate 12, preferably made from glass ceramic, underneath which four induction coils 14a to 14d are provided as heating elements. Each induction coil 14 represents or forms a cooking point 16 as is known in the art. Hob 11 could of course have more heating elements or induction coils, for example six. In a still further embodiment, hob 11 could have lots of independently operating heating elements which at least partly are arranged close to each other or even touching each other for forming virtual larger heating elements for a greater variability of formats of a cooking point. In this case, induction coils 14a to 14d form cooking points 16a to 16d. Cooking points 16 may be marked on top of the hob plate 12.

Hob 11 furthermore has a control 18 as central control for the hob and the induction coils 14. Furthermore, control 18 is connected to receiving means 19 for receiving transmitted data as explained before. Control 18 is also connected to operating elements 21 provided at, on or underneath hob plate 12. These operating elements can be formed as is known in the art.

A pot 23A is placed at cooking point 16b and, consequently, above the induction coil 14b. Pot 23 has schematically drawn at its outer side a temperature sensor 24 and a transmitter 25 for transmitting the temperature measured by the temperature sensor 24 to control 18 via receiving means 19. Furthermore, transmitter 25A transmits the information as an individual pot identifier, for example MAC 87 as denomination of pot 23A with the name 87.

Likewise, on induction coil 14 or its cooking point 16C, respectively, a second pot 23B is provided, itself also being equipped with a temperature sensor 24B and a transmitter 25B.

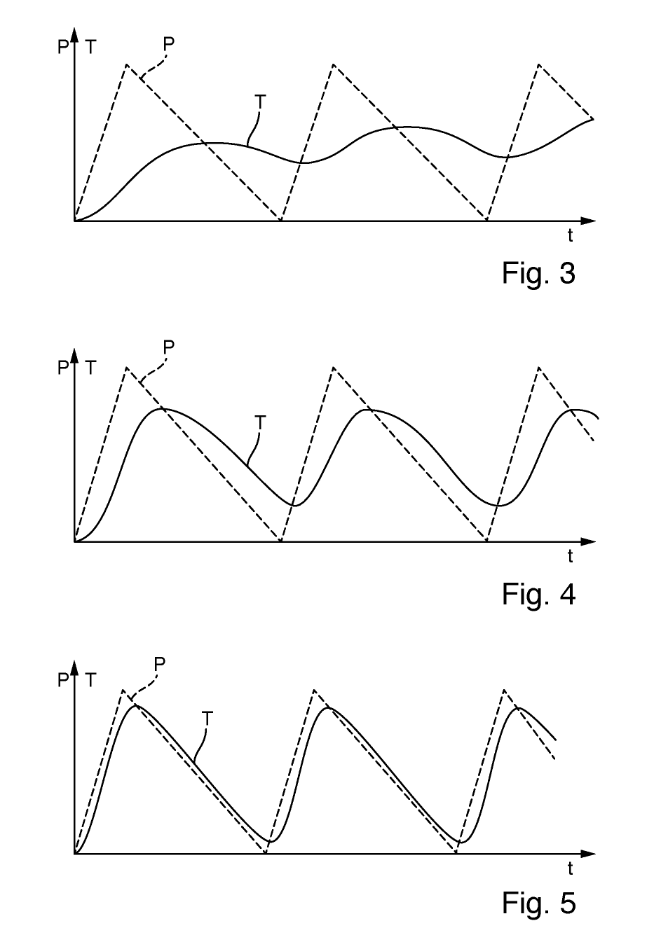

In FIG. 2 it becomes clear that, at one point of time, at least temperature sensor 24A transmits its temperature information as well as its individual pot identifier “MAC 87” to induction coil 14b of cooking point 16b. This shall represent that one cooking point or one induction coil receives transmitted data not only from one pot or only the pot placed above it, but from several pots or, in more detail, from all the pots placed on hob 11. In reality, the information sent out by transmitters 25A and 25B, which is received by receiving means 19 of control 18, with its two sets of data as represented in FIG. 2, is not sent directly to the induction coils 14, but of course to control 18. Control 18 then again adapts its powering signals to the induction coils 14 respectively.

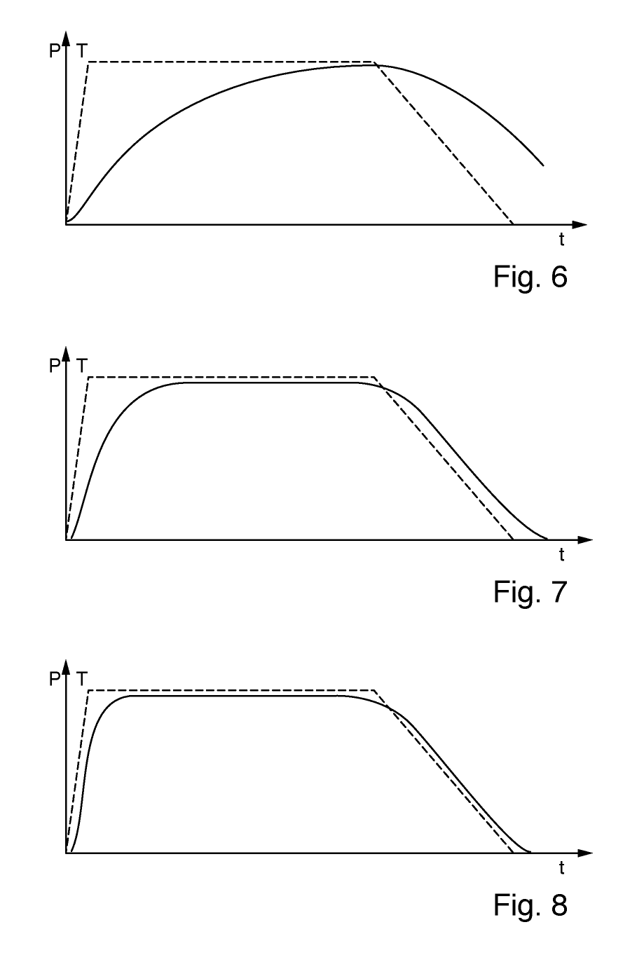

In FIG. 3 a first possible power profile template is shown. In dashed lines, the power P generated by an induction coil 14 is depicted. The maximum power P that is reached may be more than half the maximum power of induction coil 14, for example more than 1 kW or even more than 2 kW. It can also be seen that the rise of power P as well as the fall to zero are strictly linear. The duration of the rise may be measured in seconds and take about 5 seconds, whereas the fall may take between 10 and 15 seconds. The pattern of the power P is also regular and repeated, whereas between two and five such repeated patterns may be used, that means between two and five rises and falls.

The normal line represents the temperature measured by temperature sensor 24 at the pot. In this example, a heavy pot with a high amount of water or content is present, which can be seen in the slow overall rise of temperature. Irrespective of this, it can easily be seen that there is a clear relation between the power profile template and the temperature response at the temperature sensor.

As hob 11 detects via control 18 and the induction coil 14 when the first pot 23 is placed on any cooking point 16 or above an induction coil 14, respectively, and also transmitter 25 starts sending its individual pot identifier data and temperature data from temperature sensor 24, it may rather easily be recognized that the pot with this pot identifier is placed on a certain induction coil. However, in case another pot is present close to the hob or even put above hob plate 12, but not above an induction coil 14, two sets of data will be transmitted simultaneously, which makes this easy identification impossible. In this case induction coil 14b knows that any pot is placed on it and will start with the power profile template, for example according to FIG. 3. It will simply heat pot 23A as is shown in FIG. 3. Then the temperature on the pot 23A is measured by temperature sensor 24A and, together with its individual pot identifier MAC 87, transmitted to control 18. The same set of data may be transmitted from a second pot 23B placed above induction coil 14c, which, however, is not switched on or activated. As pot 23B is not heated, its temperature information transmitted to control 18 is constant and very low or corresponding to room temperature. Even if its content would be heat from an earlier cooking process, the temperature would still be relatively constant.

From comparing the different temperature data sets, control 18 may easily recognize at which pot the temperature information shows that this pot has been heated with the power profile template, so control 18 knows that pot 87 is placed above induction coil 14b at cooking point 16b. The same is made with pot 23B, if the induction coil 14c of cooking point 16c is switched on.

If pot 23A is moved during the cooking process from above induction coil 14b at cooking point 16b to cooking point 16d with induction coil 16d, two things will happen. First, induction coil 14b will recognize that the pot placed above it has been removed. Even if after a few seconds another cooking point, i.e. cooking point 16d, with its induction coil 14d is started, control 18 cannot be sure that simply pot 23A has been moved from cooking point 16b to cooking point 16d. So when induction coil 14d has recognized a pot placed above it, it will start the power profile template according to FIG. 3. If the pot with a temperature response according to FIG. 3 has the same pot identifier as the pot that has been placed on cooking point 16b shortly before, control 18 knows that it is pot 23A, which has simply been moved. In this case, if the cooking process for pot 23A on cooking point 16b had been any programmed or automatic cooking process, this can simply be resumed, as now the identity of pot 23A′, as is depicted in dashed lines above cooking point 16d, has been identified.

As has been mentioned before, FIG. 3 shows the temperature response of a big pot with a rather heavy load. FIG. 4, however, shows a medium pot with a medium load. The temperature increase or decrease is faster due to a smaller thermal capacitance than in FIG. 3 of the pot and of the load. In this case, it can be seen clearer that the temperature signal frequency and the power signal frequency are the same, only with a slight time offset, and the shape of the temperature is more similar to the power profile than in FIG. 3.

In FIG. 5, there is shown the course of temperature with a small pot and a small load of this pot. The course of temperature is even closer to the course of the power profile template. Notwithstanding this, in all three cases of FIG. 3 to FIG. 5, the temperature signal is rather characteristic and may easily be connected to the power profile template or be derived from this.

In FIG. 6, a different power profile template is shown. Rise of power P is very sharp and only lasts for about two seconds. Then for between 20 and 40 seconds, the power is constant, for example at about 15% of max. power of the induction coil. The fall of power again is slow and takes between 20 and 30 seconds. In the case of FIG. 6, it is a heavy pot with a heavy load. Even in this case, FIG. 6 makes it clear that the temperature follows the power profile rather characteristically.

In FIG. 7, corresponding to FIG. 4, the temperature T belongs to a medium pot with a medium-sized load in it. As has been the case before, the course of temperature is much closer to the power profile template due to the smaller thermal capacitance. This becomes even clearer from FIG. 8, where with a small pot and a small load with a low thermal capacitance, the temperature follows the power rather closely.

Further power profile templates are feasible and be easily conceived by a person skilled in the art. Also, a zero power phase may be integrated, although it is deemed not to be so characteristic as a rise and fall of power as depicted herein.

That which is claimed:

1. A method for detecting the identity of a pot on a cooking point of a hob with a hob plate, wherein said hob comprises at least one heating element placed underneath said hob plate, said cooking point being provided with a pot sensing means for detecting a pot present on said cooking point and being connected to a hob control comprising a receiver, wherein a temperature sensor and a transmitter are attached to said pot, the method comprising:
transmitting, via said transmitter, at least two sets of data to said receiver and to said hob control, wherein a first set of data is an individual pot identifier and a second set of data is related to a temperature state of said pot measured by said temperature sensor;
defining a power profile template for said heating element and in an instance in which said pot sensing means has detected a presence of any pot, said heating element is activated with said power profile template to provoke a temperature change in said pot present on it, wherein a given delay due to a thermal capacitance of said pot is given;
detecting, via said temperature sensor at said pot, with said delay, a profile of said power represented in said temperature change; and
sending temperature information via said transmitter back to said hob control to determine whether said temperature profile detected by said temperature sensor at said pot corresponds to said power profile template generated by said heating element, and wherein in case of a match said pot with said pot identifier is recognized to be placed on said cooking point.

2. The method according to claim 1, wherein transmitted data related to said temperature of said pot is used to adapt said power generated by said heating elements when said pot is moved from one cooking point to another cooking point such that a temperature at said pot is being kept essentially constant irrespective of a location of said pot.

3. The method according to claim 1, wherein in said hob control it is defined that a specific pot is used with a specific predefined temperature, wherein said pot is set on said hob at a cooking point and by actuating only one control element after detection and identification of said specific pot on said cooking point said at least one heating element beneath said pot is activated with an energy or a power level to heat said pot with said specific predefined temperature.

4. The method according to claim 3, wherein said temperature is controlled via a second set of data with said temperature information of said pot.

5. The method according to claim 1, wherein said heating element comprises an induction heating element.

6. The method according to claim 5, wherein said induction heating element is provided with an induction heating coil, said induction heating coil comprises said pot sensing means.

7. The method according to claim 1, wherein said power profile template comprises at least one rise of said power to a maximum power level and at least one fall of said power to zero power level.

8. The method according to claim 7, wherein said power profile template comprises at least one phase of constant power, wherein said phase of constant power differs from zero power.

9. The method according to claim 5, wherein in said power profile template a rise or a fall of said power have a specific rise duration and a specific fall duration and take place continuously.

10. The method according to claim 9, wherein said rise of power takes less time than said fall of power.

11. The method according to claim 5, wherein in said power profile template between a rise and a fall of power there is a phase of constant power for a specific continuous duration.

12. The method according to claim 11, wherein said continuous duration is longer than a duration of said rise or said fall of power.

13. A system of a hob comprising:
a hob plate; and
a cooking point at said hob plate together with a pot, wherein said hob comprises at least one heating element placed underneath said hob plate and wherein said cooking point is provided with a pot sensing means for detecting presence of the pot on said cooking point,
wherein said hob further comprises a control and receiving means connected to said control,
wherein said pot is provided with a temperature sensor and a transmitter attached to said pot,
wherein said transmitter is transmitting at least two sets of data, and
wherein a first set of data is an individual pot identifier and a second set of data is related to said temperature state of said pot being measured by said temperature sensor.
